(19) United States
(12) Patent Application Publication
(10) Pub. No.: US 2006/0143313 A1
(43) Pub. Date: Jun. 29, 2006

(54) Method for accessing a storage device

(75) Inventors: Shuai Tan, Beijing (CN); Jian Liu, Beijing (CN); Zhengjun Zhou, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 11/304,100

(22) Filed: Dec. 14, 2005

(30) Foreign Application Priority Data
Dec. 24, 2004 (CN) 200410102551.5

(51) Int. Cl. G06F 3/00

(52) U.S. Cl. 710/3

(57) ABSTRACT

Techniques for exchanging data between a storage device and a device without having data buffered in a memory of a computing device are disclosed. According to one aspect of the techniques, a method for an external device accessing a storage device via a computing device comprises sending a request to a file system of the storage device for accessing the storage device, responding with an accessing address in the storage device, and accessing directly the storage device in accordance with the accessing address without going over an external bus of a CPU in the computing device.

### BACKGROUND OF THE INVENTION

1. Field of the Invention

The present invention relates to data accessing operations, and more particularly to methods for accessing a storage device more efficiently with minimum impact on system resources.

2. Description of Related Art

In computers and systems, a file system is a collection of structures in a storage device storing and managing data. Among other things, the file system is mainly used to perform three tasks which are to trace and record used space as well as free space in the storage device, preserve names of list and files, trace and record the physical position where each file is stored.

As shown in FIG. 1, a conventional computer system 100 comprises a CPU 102, a memory module 104, an Input/Output (I/O) controller 106, and external functional devices 108. To understand the operation of the system 100, one of the devices 108 is shown separately and labeled by 110. In the conventional computer system, when there is a need to write a data file from the external device 110 (e.g., a camera device) into a storage device 112, the computer system 100 needs to put the data file into the memory 104 via the I/O controller 106, and then writes the data files to the storage device 110 via the I/O controller 106.

When the I/O controller 106 needs to read the file from the storage device 110, the computer system 100 firstly puts the data file from the storage device 110 into the memory 104 via the I/O controller 106 then reads the data file from the memory 104 to an external device via the I/O controller 106.

As observed, the accessing efficiency is very much subject to the transmission speed of the I/O controller 106 and the memory 104, thus resulting in not only low efficiency but also serious waste of system resources, especially when the file is of relatively large size.

Thus there is a need for techniques for accessing the storage device more efficiently with minimum impact on system resources.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, techniques for exchanging data between a storage device and a device without having data buffered in a memory of a computing device are disclosed. According to one aspect of the techniques, a method for an external device accessing a storage device via a computing device comprises sending a request to a file system of the storage device for accessing the storage device; responding with an accessing address in the storage device; and accessing directly the storage device in accordance with the accessing address without going over an external bus of a CPU in the computing device.

One of the features, benefits and advantages in the present invention is to provide techniques for exchanging data between two devices without impacting system performance of a computing system and with less dependency on the system resources of the computing device.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is an example block diagram showing a conventional computer system;

FIG. 2 is an exemplary block diagram showing a computer system according to one embodiment of the present invention;

FIG. 3 is a corresponding diagram showing data transmission process of the computer system of FIG. 2;

FIG. 4 is a flowchart or process showing a reading operation to an external storage device of the computer system; and

FIG. 5 is a flow chart showing a writing operation to the external storage.

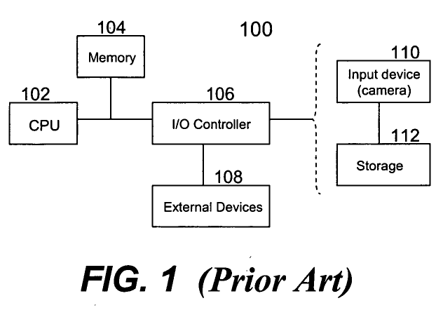

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

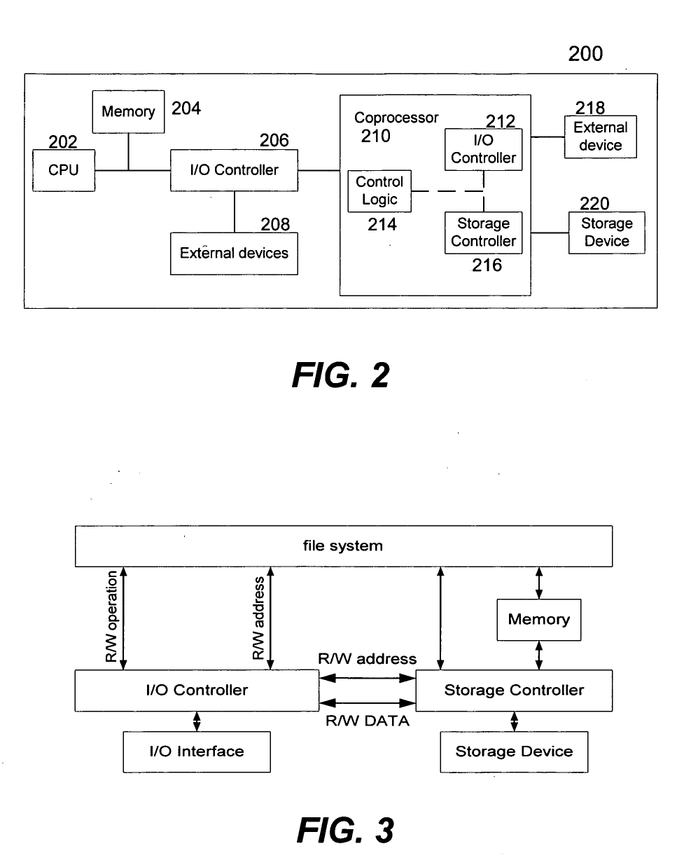

Referring now to the drawings, in which like numerals refer to like parts throughout the several views. Referring to FIG. 2, there shows a system 200 that includes a computing device (e.g., a computer) including a CPU 202, a memory 204, and an Input/Output (I/O) controller 206, and external devices 218. To clearly illustrate one of the features in the present invention, one of the external devices 208 is shown and labeled as 218. The external device 218 is accessing a storage device via the computer.

As will be explained below, as one of the features, advantages and benefits in the present invention, a coprocessor 210 is provided and coupled between the computer and the external device 218 and the storage device 220. In other words, the coprocessor 210 facilitates a data flow between the external device 218 and the storage device 220 with the assistance from the computer, thus reducing significantly the impact on the resources in the computer as well as the dependency on the computer.

As illustrated, the coprocessor or a circuit 210 includes a control logic 214, an I/O controller 212 (corresponding to the I/O controller 206) and a storage controller 216. The I/O controller 212, the coprocessor 210 and the memory 204 are coupled to an external bus of the CPU 202. The coprocessor 210 is a special-purpose processing unit that assists the CPU 202 in performing certain types of operations. For example, the coprocessor 210 in one embodiment specially processes a large amount of image data from the external device 218 to the storage device 220. In particularly, the I/O controller 212 is used to specially deal with data from/to an external device, such as a digital camera. The storage controller 216 is used to control access operation to the storage device. The control logic 214 is used to control the operation of the I/O controller 212 and the storage controller 216.

In one embodiment, a file system is built in a storage device for managing and storing data. The file system generally includes a file allocate table (FAT) and a file describe table (FDT). The FAT is a chain used to record physical address of files with clusters as units. A cluster is a unit forming by a physical position of a certain line type area. As known to those skilled in the art, before the storage device is accessed, the file system thereof is read first into the memory 204 by the CPU 202.

Referring to FIG. 3, there shows an accessing operation to the storage device by an external device. FIG. 3 may be understood in conjunction with FIG. 2. The I/O controller sends an accessing request to the file system when it needs to read files from the storage device or to write files into the storage device. The file system provides an accessing address to the I/O controller of the coprocessor. Then, the I/O controller of the coprocessor makes an accessing request for the storage controller. Finally, the data files are directly transmitted between the output/input controller and the storage device according to the accessing address controlled by the control logic of the coprocessor. It should be noted that the access request may be a writing request or a reading request.

When the I/O controller sends a reading request to the file system, which contains a filename of an object file, the file system will locate addresses in the storage device where the object file is stored by looking up the FDT and FAT according the filename, and then responds the storage addresses of the object file to the I/O controller. The length of the object file might be provided to the I/O controller along with the storage addresses.

It should be noted that the storage address may be a beginning address of a data file in one embodiment or may be block addresses of the data file in another embodiment. Additionally, the block addresses might be provided to the I/O controller in many ways, such as all of the addresses provided at one time or one block address provided at one time. After the I/O controller reads out the data from the beginning address or one block address, a next address or a next block address will be obtained from the file system.

When an I/O controller sends a writing request to the file system, the file system allocates an address in the storage device where a data file is written by looking up the FAT. The storage address may be a beginning address for storing the file in one embodiment or may be block addresses for storing the file in another embodiment. Additionally, the block addresses might be provided to an I/O controller in many ways, such as all of the addresses provided at one time or one block address provided at one time. After the I/O controller writes the data into the beginning address or one block address, a next address or a next block address will be obtained from the file system.

When the I/O controller finishes the writing process for the file, the file system shall be noticed to deal with information related to the file, such as to record physical position taken up by the file in FAT, to record attribute information of the file in FAT etc. When the I/O controller sends a reading request or a writing request, an interrupt operation may be adopted by the file system. Namely, creating an interrupt signal from the I/O controller, the CPU responds to the interrupt signal to carry out the procedure of the file system. An inquiry mode can also be adopted by the file system to read or write the file. Namely, the CPU uses the circulation (orders) mode to consult value of a register of the I/O controller or fixed address to decide whether it is the query state.

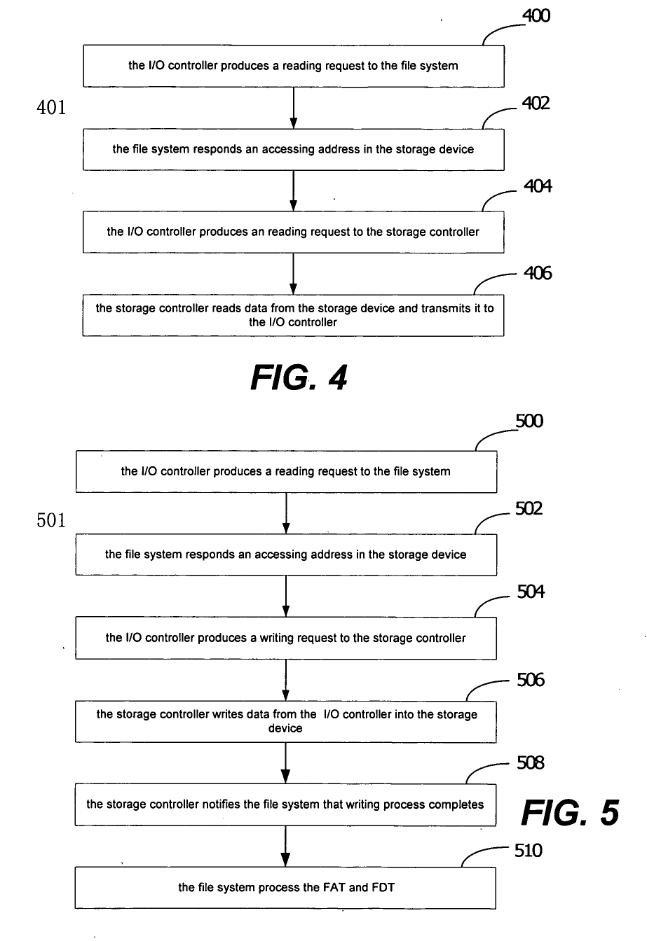

To further understand the present invention, the operation for reading a file from the storage device is specifically described in accordance with a flowchart or process 401 shown in FIG. 4. At 400, an I/O controller produces an interrupt signal to read a file and transmit information of the file, such as a path and a filename, to the file system.

Depending on implementation, there are essentially two ways for the transmission. One is that when the reading request takes place, the I/O controller reserves the path and the filename of the file into a register (or predetermining addresses) thereof, the CPU periodically reads the register (or predetermining addresses) to acquire the information of the file. The other is that when the reading request takes place, the reading request is carried out by other procedures running in the CPU and then the information related to the file is preserved somewhere in the memory where the file system acquires the file's information.

At 402, basing on the filename, the file system retrieves the storage address from the FDT and the FAT where the address list of the file is stored and returns the storage address to the I/O controller. At 404, the I/O controller sends a reading request to the storage controller and provides the storage address of the file. At 406, the storage controller relies on the storage address to read data from the storage device and sends the data to the I/O controller directly until all the data has been transmitted.

As shown in FIGS. 3 and 5, to further understand the present invention, the operation for writing a file into the storage device is specifically described in accordance with a flowchart or process 501 shown in FIG. 5. At 500, an I/O controller produces an interrupt signal to write a file and delivers the filename of the pending file to the file system. At 502, the file system allocates storage blocks for the pending file according to the FAT and returns the addresses of all the storage blocks to the I/O controller.

At 504, the I/O controller sends a writing request to the storage controller and provides the address of the block storages allocated to the file. At 506, the I/O controller directly transmits data of the file to the storage controller and then the storage controller relies on the storage address allocated to the file to write the data into the storage device until all the data has been written.

At 508, the storage controller notifies the file system that writing process for the file has ended. At 510, the file system records physical position possessed by the file in FAT, and records attribute information such as the filename and size of the file.

Combining with FIGS. 3-5, it can be appreciated that when the I/O controller writes data from the external device (such as a digital camera) into a storage device, data transmission can be achieved in the coprocessor with high efficiency and proceeded without interrupting any operations of the CPU, or consuming many resources associated with the CPU. As such, not only is the data transmission efficiency high, but also it does not take up the exterior bus of the CPU in the system, thus vacating the bandwidth of the exterior bus of the CPU completely and lowering significantly the occupancy of the system resources.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments

What is claimed is:

1. A method for an external device accessing a storage device via a computing device, the method comprising:
sending a request to a file system of the storage device for accessing the storage device;
responding with an accessing address in the storage device; and
accessing directly the storage device in accordance with the accessing address without going over an external bus of a CPU in the computing device.

2. The method as claimed in claim 1, wherein a processing unit is provided to couple the external device and the storage device to the computing device.

3. The method as claimed in claim 2, wherein the processing unit includes a control logic controlling operations of two respective controllers, each coupled to one of the storage device to the external device.

4. The method as claimed in claim 3, wherein one of the two controllers to be coupled to the external device is part of the computing device.

5. The method as claimed in claim 2, wherein the processing unit facilitates data exchanging between the storage device to the external device without having the data buffered in a memory of the computing device.

6. The method as claimed in claim 1, wherein the request for accessing the storage device comprises at least two types: a first type is a reading request to the storage device, and a second type is a writing request to the storage device.

7. The method as claimed in claim 6, wherein, when the request is the reading request, the request contains a filename of a data file.

8. The method as claimed in claim 7, wherein the file system looks up addresses allocated to the data file in a FAT thereof, and provides the corresponding accessing address.

9. The method as claimed in claim 7, wherein, when the request is a writing request, the file system looks up free addresses in a FAT thereof, and provides the corresponding accessing address.

10. The method as claimed in claim 9, further comprising recording information of the data file in the file system.

11. The method as claimed in claim 10, wherein the information includes physical address possessed by the data file and corresponding attribute information.

12. A method for an external device accessing a storage device via a computing device, the method comprising:
sending, by an I/O controller, a request for accessing a storage device to a CPU in the computing device;
providing an accessing address in the storage device to the I/O controller as a response of the request;
forwarding the accessing address to a storage controller; and
directly accessing the storage device according to the accessing address by the storage controller without having data going over a data bus in the computing device.

13. The method as claimed in claim 12, wherein a processing unit is provided to coupled the external device and/or the storage device to the computing device.

14. The method as claimed in claim 13, wherein the processing unit further comprises a control logic for controlling directly communication between the storage controller and the I/O controller.
